(19) United States
(12) Patent Application Publication
(10) Pub. No.: US 2016/0330453 A1
(43) Pub. Date: Nov. 10, 2016

(54) Parameter Set Header

(71) Applicant: Cisco Technology, Inc., San Jose, CA (US)

(72) Inventors: Rui Zhang, Pleasanton, CA (US); Sijia Chen, Hangzhou (CN)

(21) Appl. No.: 14/704,161

(22) Filed: May 5, 2015

(51) Int. Cl. H04N 19/154; H04W 88/04; H04N 19/132; H04N 19/169; H04N 19/895; H04N 19/59

(52) U.S. Cl. CPC H04N 19/154; H04N 19/895; H04N 19/59; H04N 19/132; H04N 19/188; H04W 88/04

(57) ABSTRACT

In one implementation, multiple parameter sets associated with different resolutions for a media stream are identified. A parameter set table including the plurality of parameter sets and associated resolutions is generated. After, establishing a communication session with an endpoint, the parameter set table is sent to the endpoint as part of the communication session. Also through the same communication session, video data of the media stream is sent to the endpoint.

### TECHNICAL FIELD

This disclosure relates in general to the field of video compression, and more particularly, to parameter sets for video compression.

### BACKGROUND

Various video compression formats are established by industry drafts. Examples include H.264, moving picture experts group (MPEG) 4, high efficiency video coding (HEVC), or other standards.

In video conferencing application, the compressed video is being transmitted through the network, where the packet loss may concur and hence impact the receiving quality. Compared with traditional video conference within enterprise network, on cloud-based and/or mobile video calls or video conferences network losses may be greater and more common. Furthermore, the more diversified mobile device types involved in the conference and the ability of orientation changes on the mobile devices introduce more diversified and changing video resolutions during the conference call. Error concealment techniques attempt to mask the packet loss. In real time applications, error concealment is especially challenging, because concealing the lost packets with previous received packets may disrupt the required frame rate of the video stream. In addition, when the resolution or screen size of the endpoint changes, error concealment faces additional challenges.

### BRIEF DESCRIPTION OF THE DRAWINGS

Exemplary embodiments of the present embodiments are described herein with reference to the following drawings.

FIG. 1 illustrates an example of lost parameter information.

FIG. 2 illustrates an example system for generation of parameter set information.

FIG. 3 illustrates an example parameter set selection process.

FIG. 4 illustrates an example selection of a correction technique based on the parameter set information.

FIG. 5 illustrates an example network device for the system of FIG. 1.

FIG. 6 illustrates an example flowchart for creating a parameter set table.

FIG. 7 illustrates an example flowchart for parameter set replacement based on the parameter set table.

### DESCRIPTION OF EXAMPLE EMBODIMENTS

### Overview

In an embodiment, systems and methods are described for identifying a parameter set table that associates sequence parameter set (SPS) identifiers and picture parameter set (PPS) identifiers, receiving a network abstraction layer unit stream including video data, identifying a PPS from the network abstract layer unit stream, accessing the parameter set table using an identifier from the PPS received in the network abstract layer unit stream, and retrieving an SPS identifier from the parameter set table.

In an embodiment, systems and methods are described for identifying a plurality of parameter sets associated with different resolutions for a media stream, generating a parameter set table including the plurality of parameter sets and associated resolutions, establishing a communication session with an endpoint, sending the parameter set table to the endpoint as part of the communication session, and sending video data of the media stream to the endpoint as part of the communication session.

### EXAMPLE EMBODIMENTS

Video compression formats (e.g., H.264 or H.265) may use a network abstraction layer (NAL) unit including a syntax structure containing an indication of the type of data to follow and bytes containing that data in a compressed form interspersed with emulation prevention bytes. In these video compression formats, resolution and other video parameters may be described in a sequence parameter set (SPS) and/or a picture parameter sets (PPS). The SPS applies to a series of consecutive coded video pictures called a coded video sequence. The PPS applies one or more individual pictures within a coded video sequence.

A NAL unit may include a PPS identifier that refers to the content of the corresponding picture parameter set. Similarly, a picture parameter set contains an identifier that refers to the corresponding relevant sequence parameter set. The SPS and PPS may be sent in advance of the NAL units.

The coded video sequence may include different types of frames. A reference frame upon which other frames are based is an I-frame. A prediction frame, or P-frame, is based on earlier frames, such as I-frames. An instantaneous decoder refresh or independent decodable reconstruction (IDR) frame includes an IDR encoded picture that is flagged as cause the decoding process to mark all past reference pictures or I-frames as unusable for reference in response to receipt or decoding of the IDR picture. All frames that follow the IDR frame may be decoded without referring to any frame that precedes the IDR frame. The first frame of the coded video sequence is an IDR frame.

Video decoders may also perform error concealment. In error concealment, a decoder, when handling a predicted frame or P frame, may examine previous frames to recover the current lost picture information. The error concealment may depend on the resolution of the predicted frame with respect to the resolution of the previous frame. The decoder may refer to the SPS or PPS to determine whether the resolution has changed. In addition, B frames, or bi-directional predicted frames, may be used for error concealment.

However, when the communication is lossy and the PPS and/or SPS have been lost, the decoder may not be aware that the resolution has changed between the current frames and previous frames. Thus, error concealment may be ineffective when a PPS or an SPS is lost. When a decoder tries to attempt error concealment at the time that there is resolution change between reference data and current data and that decoder is unaware of the change, a mismatch of the target reconstruction size and motion vectors may result in very bad viewer experience. This is because of the nature of reconstruction in raster scanning order.

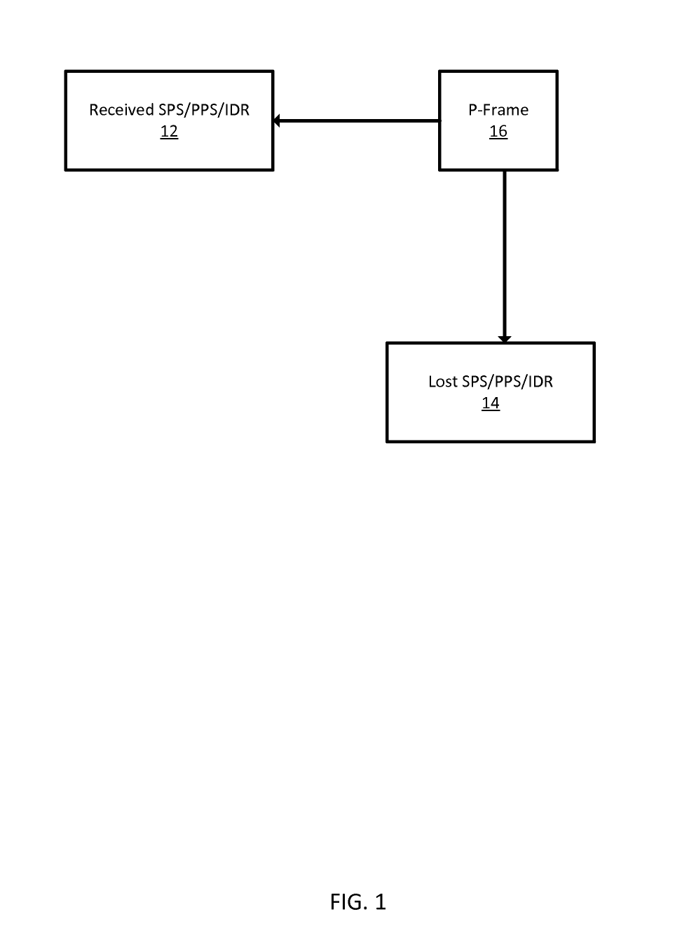

FIG. 1 illustrates an example P-frame 16. Each P-frame may be associated with an IDR, SPS and/or a PPS. Another problem experienced when the SPS or PPS is lost relates to non-unique identifiers. A NAL unit or P-frame 16 may refer to a PPS according to the PPS identifier and successively refer to an SPS according to the SPS identifier that this PPS identifier is uniquely referred to. It is possible that the decoder incorrectly determines a P frame may refer to a frame (e.g., incorrect reference frame 12) that was successfully received, but P frame 16 is actually referred to another frame that is lost (e.g. correct reference frame 14). The incorrect reference 12 frame may have the same PPS identifier, and hence the same SPS identifier of the actual reference frame 14. The decoder may be unaware of the mismatch and unable to report the out-of-sync status. Thus, the system cannot repair loss of quality in real-time communication when SPS/PPS information is lost and a non-unique identifier is used.

The following embodiments include one or more techniques to these problems resulting from a lost SPS or PPS. In one example, the SPS is reused in particular instances such as when the resolution is consistent. In another example, the PPS identifiers are adjusted to avoid the ambiguity in referring to the SPS or PPS under lossy transmission. In another example, a table or other mapping between PPS identifiers and SPS identifiers or vice versa is generated so that resolution and dependency can be confirmed.

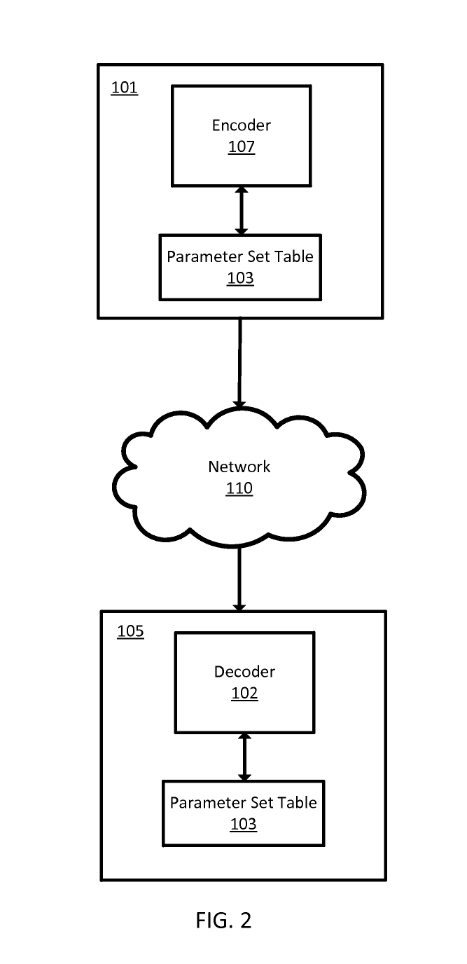

FIG. 2 illustrates an example system for correcting lost parameter sets in encoded video. A local endpoint device 101 includes an encoder 107 and a parameter set table 103 and is in communication and coupled with an external network 110 (e.g., Internet). The external network 110 provides communication with a remote endpoint device 105, which includes a decoder 102. More endpoint devices may be included, and any of the endpoint devices may be personal computers, mobile devices, set top boxes, tablet computers, or any computing device configured for network communication. Between the local endpoint device 101 and/or the remote endpoint device 105 and the external network 110 may be a network device such as a server, a router, a gateway, or another network device. Additional, different, or fewer components may be included.

According to some video compression specifications (e.g., the H.264 or H.265 specifications), information about resolution changes is only transmitted in the SPS, which is typically transmitted once before the first frame (e.g., an IDR frame) of the new resolution. If this information is lost, error concealment is particularly challenging because the decoder 102 has no information about the new resolution, and the normal previous reference frame based concealment procedure breaks down.

Before the first frame of the communication session or video call, a parameter set table 103 may be sent from the encoder 107 to the decoder 102. The parameter set table 103 may include multiple pairs of SPS and PPS. There may be at least one SPS-PPS pair for each resolution supported by the communication session. For each resolution, there is a unique SPS identifier and a unique set of PPS identifiers (e.g. PPSid=0, 1, 2 for 720p and PPSid=3, 4, 5 for 1080p). The parameter set table 103 establishes mappings between each resolution and the SPS identifier and PPS identifier that are not allowed to change during the call.

An example parameter set table 103 may include:

TABLE 1

| SPS Identifier | Resolution | PPS Identifier |
|---|---|---|
| S1 | R1 | P1 |
| S1 | R1 | P2 |
| S2 | R2 | P3 |
| S2 | R2 | P4 |
| S3 | R3 | P5 |
| S3 | R3 | P6 |

The values S1-S3 for the SPS identifier may have numerical values between 0 and 31 and the values P1-P6 for the PPS identifier may have numerical values between 0 and 255, as described by H.264 (e.g., Version 9 of the H.264/MPEG-4 AVC video compression standard implemented in February 2014 and available at the ITU website as “T-REC-H.264-201402-I”.)

Another example of the parameter set table 103 may include:

TABLE 2

| SPS Identifier | Resolution | PPS Identifier |
|---|---|---|
| S1 | 1280 × 720 | P1 |
| S1 | 1280 × 720 | P2 |
| S2 | 960 × 540 | P3 |
| S2 | 960 × 540 | P4 |
| S3 | 640 × 360 | P5 |
| S3 | 640 × 360 | P6 |

The values S1-S3 for the SPS identifier may have numerical values between 0 and 31 and the corresponding values for the resolution may be measured in height pixels and width pixels. One of the resolutions may correspond to a landscape orientation of a mobile device, and another of the resolutions may correspond to a portrait orientation for the mobile device. The mobile device may switch between the portrait orientation and the landscape orientation based on orientation data generated from a gyroscope, accelerometers, or magnetic sensor.

The resolution may be derived from one or more data types or syntax described in the SPS. Examples include pic_width_in_mbs_minus1, pic_height_in_map_units_minus1, frame_cropping_flag, frame_crop_left_offset, frame_crop_right_offset, frame_crop_top_offset, and frame_crop_bottom_offset. The resolution may be calculated based on the picture width (e.g., pic_width_in_mbs_minus1) and picture height (e.g., pic_height_in_map_units_minus1). The resolution may be calculated based on various offsets, cropping values, or other adjustments. The resolution may be calculated based on a picture width and a picture height.

In one example, the parameter set table 103 is a static table that the encoder 107 defines and sends to the decoder 102 before the stream. In one example, the parameter set table 103 is a dynamic table that the encoder 107 builds over time and sends to the decoder 102. Each time the encoder 107 is asked by the upper application to encode a new resolution, the encoder 107 checks the parameter set table 103 to determine if there is an entry for the associated SPS identifier. If there is no associated SPS identifier, the encoder 107 adds an entry to the parameter set table 103. Correspondingly, the decoder 102 generates or builds up the parameter set table 103 while receiving SPS/PPS packets. Alternatively, the decoder 102 may build the parameter set table 103 as individual parameter sets are received from the encoder 107.

The local endpoint device 101 may identify a parameter set table that associates SPS identifiers and PPS identifiers. For example, the local endpoint device 101 may access the parameter set table 103 from memory.

A communication session is established between the local endpoint device 101 and the remote endpoint device 105. The communication session may be established using session initiation protocol (SIP), in which one of the endpoints sends an invite message that is accepted by the other endpoint. Once the communication session is established, video data is exchanged between the endpoints using H.264, H.265 or another video compression format.

The communication session may exchange data between the local endpoint device 101 and the remote endpoint device 105 that is organized in NAL units. The local endpoint device 101 sends a stream of NAL units to the remote endpoint device 105, and the remote endpoint device 105 sends a stream of NAL units to the local endpoint device 101. Each NAL unit may have a predetermined size. In one example, the first one or two bytes of the NAL unit includes a header that describes the type of NAL unit. The type of NAL unit may include video coding layer (VCL) units and non-VCL NAL units. The VCL units contain data that representing the video. The non-VCL NAL units may include the parameter sets, such as the SPS and the PPS. The non-VCL NAL units may include enhancement data or timing data, which are not essential to decoding the video data but may provide additional functionality associated with the video.

The remote endpoint device 105 may identify a PPS from the NAL unit stream. The remote endpoint device 105 may monitor the headers of the NAL units and identify non-VCL NAL units include the PPS. The headers may specify that the NAL unit includes a PPS. From the PPS, the remote endpoint device 105 identifies a SPS identifier. The remote endpoint device 105 may access the parameter set table 103 using the SPS identifier from the PPS.

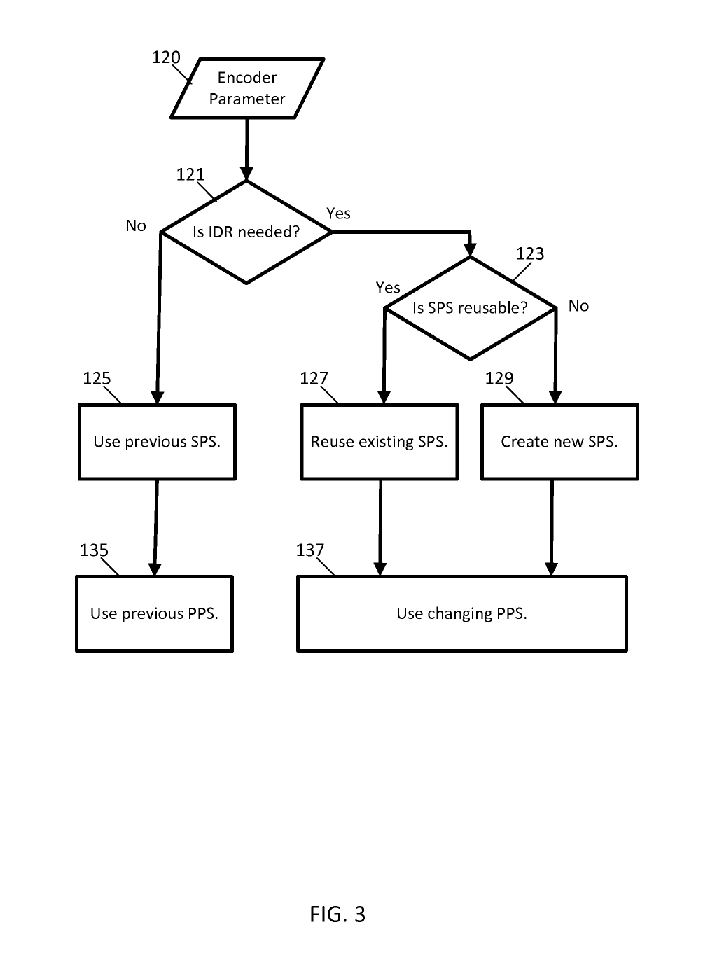

FIG. 3 illustrates an example selection of a SPS/PPS generation technique. The encoder configuration parameter 120 is data received from an upper layer application. The encoder 107 may also receive raw video data from the upper layer application, and the encoder 107 is configured to encode the raw video into an encoded bit stream as a function of the encoder parameter 120. Examples for the encoder configuration parameter include encoding width, encoding height encoding frame rate, or other parameters.

At decision 121, the encoder 107 determines whether an IDR needs to be generated. When there is no need to generate an IDR, then the video can be generated using previously header information. In this instance, the encoder 107 may use a previous SPS/PPS, as shown at blocks 125 and 135.

When a new IDR is needed, the encoder 107 may proceed to decision 123. At decision 123, the encoder 107 determines whether or not some previous SPS is reusable. For example, the SPS is reusable when the current encoding resolution has been encoded before and there is one SPS listed already in the parameter set table 103. When the SPS is reusable, the encoder 107 access the previously stored SPS from memory, as shown by block 127 and sends the previously stored SPS to the communication session and the remote endpoint device 105.

The encoder 107 may determine that the SPS is not reusable because there is no SPS listed in the parameter set table 103 that represents the current resolution to be encoded. In this case the encoder 107 creates a new SPS, as shown by block 129, and generate a new entry to the parameter set table 103. In either instance, whether or not a previously stored SPS or a new SPS is used, the encoder 107 may send a changing PPS or a new PPS, as shown by block 137. The new SPS in block 129 and/or the new PPS in block 137 may be added to the parameter set table 103.

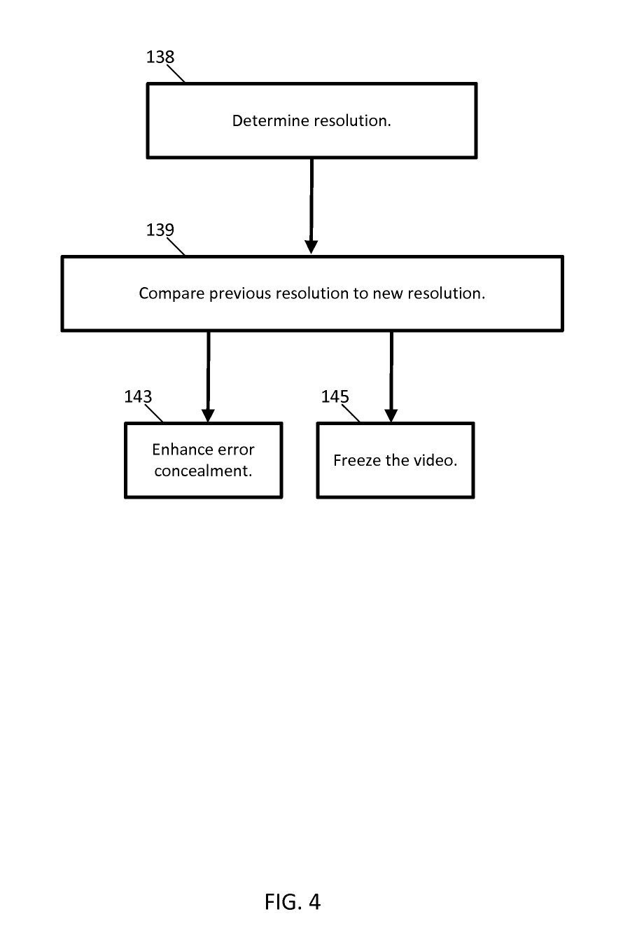

FIG. 4 illustrates an example selection of a correction technique based on the parameter set information received at the decoder 102. Because the PPS identifier is sent in the frame headers, the decoder 102 may derive the resolution from the frame header and do proper concealment depending on whether the resolution has changed or not, and then decide further what is the best action item to provide the best possible user experiences.

As discussed in FIG. 4, the resolution of the current video frames is determined at block 138 according to the PPS identifier. The parsed or determined resolution is compared to previous resolution at block 139. The comparison may involve determining a difference between the current resolution and the previous resolution. The decoder 102 identifies that a resolution specified by the PPS from the network abstract layer unit stream is different than a previously received SPS. The difference may be positive or negative depending on whether the current resolution or the previous resolution is greater. The difference may be an absolution difference such as the total number of pixels in the current resolution minus the total number of pixels in the previous resolution. The difference could be an orientation change, for example, from landscape mode to portrait mode on mobile devices.

The decoder 102 may determine an error concealment technique based on the difference between the current resolution and the previous resolution. When the difference is a particular value or a first range of values, one error concealment procedure, technique, or algorithm may be applied. When the difference is another value, or range of values, another error concealment procedure, technique, or algorithm may be applied. The decoder 102 can also decide to not apply any error concealment algorithm but rather freeze the video based on the resolution specified by the SPS from the network abstract layer unit stream being different than the previously received SPS. That is, because the resolution has changed, the decoder 102 does not attempt to recreate the lost packet.

In other words, the decoder 102 may be configured to enhance or modify the error concealment procedure based on the resolution difference, as shown by block 143. The decoder 102 modifies an error concealment algorithm based on the resolution specified by the PPS from the network abstract layer unit stream being different than the previously received SPS. For example, the decoder 102 may upsample or downsample the previously receive picture data to better match the resolution of the new data. Consider an example in which the previous resolution size is 1280×720 pixels and the later resolution is 640×360 pixels. For the 640×360 frame, the decoder 102 requests a reference frame for error concealment, but the decoder 102 cannot retrieve reference frames of size 640×360 in the decoder buffer or memory. The decoder 102 may downsample 1280×720 to 640×360 as the reference frame for the 640×360 frame to perform error-concealment. In another example, when the previous resolution size is 640×360 pixels and the later resolution is 1280×720 pixels. For the 1280×720 frame, the decoder 102 requests a reference frame for error concealment, but the decoder 102 cannot retrieve reference frames of size 1280×720 in the decoder buffer or memory. The decoder 102 may upsample 640×360 to 1280×720 as the reference frame for the 1280×720 frame to perform error-concealment.

In some embodiments, the decoder 102 may be configured to freeze the video based on the resolution difference, as shown by block 145. For example, the decoder 102 may determine that error concealment procedures will be ineffective, and the best concealment of the missing frames or parameter sets may be to freeze the video for a small amount of time. The decoder 102 identifies that there has been a resolution change and freezes the picture. That is, the most recent received frame is displayed until more picture data is received.

In one example, the decoder 102 repeatedly displays a particular video frame of the video data based on the resolution specified by the PPS from the network abstract layer unit stream being different than the previously received SPS. When the decoder 102 receives a subsequent PPS or SPS in the network abstract layer unit stream and advances, unfreezes, or stops repeatedly displaying the frame of the video data previously frozen in response to the subsequent PPS or SPS.

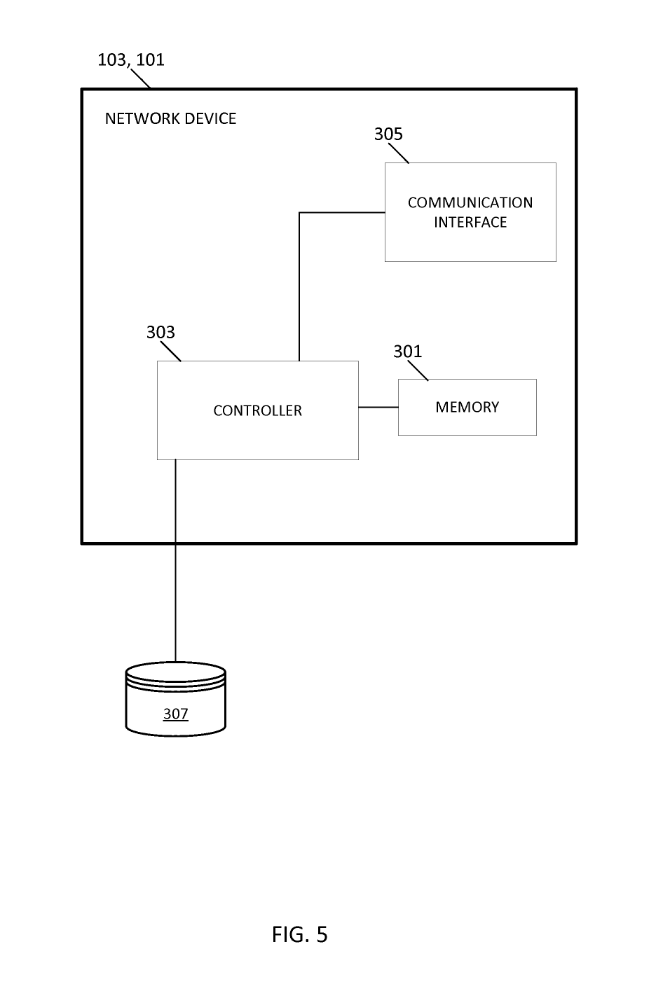

FIG. 5 illustrates an example network device such as the remote endpoint device 105 or the local endpoint device 101 for the networks of FIG. 1, which may be referred to alternatively or collectively as a computing device. The computing device includes at least a memory 301, a controller 303, and a communication interface 305. Additional, different, or fewer components may be provided. Different network devices may have the same or different arrangement of components.

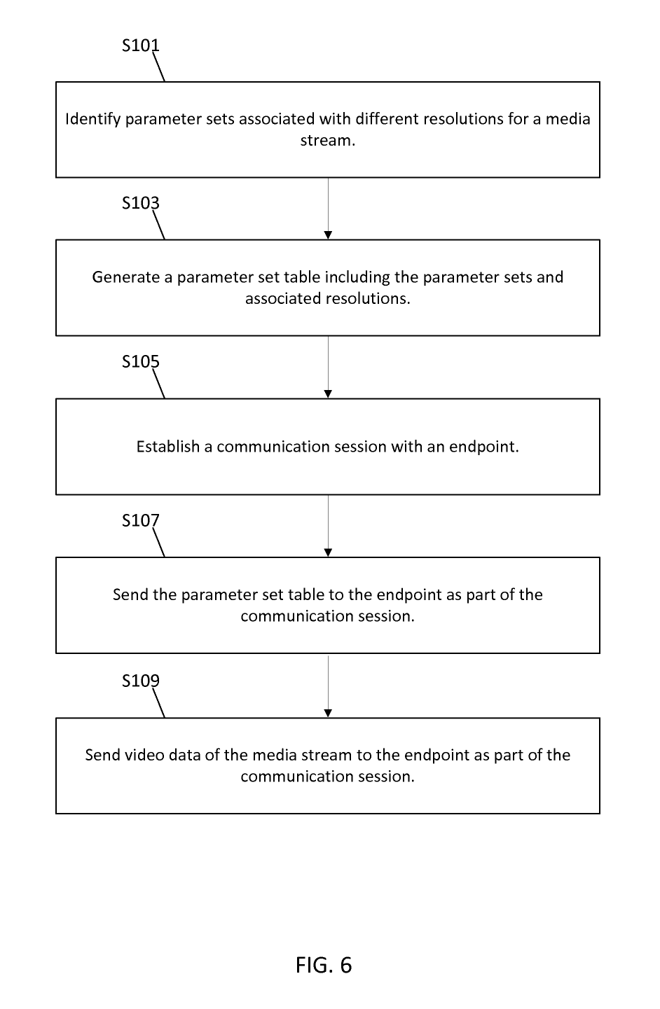

FIG. 6 illustrates an example flowchart for the computing device acting as an encoder. Additional, different, or fewer acts may be provided. The acts are performed in the order shown or other orders. The acts may also be repeated.

At act S101, the communication interface 305 or the controller 303 identifies multiple parameter sets associated with different resolutions for a media stream. The parameter sets may correspond to potential resolutions used to communicate with another endpoint (a remote endpoint). The communication interface 305 or the controller 303 may receive a communication request from the remote endpoint. The communication request may be a session initiation protocol (SIP) request. The communication request may include resolution codes for resolutions that the remote endpoint is configured to receive. The communication request may include resolution codes for a subset of resolutions that the remote endpoint would like to communicate with for the particular media stream of the communication request. The controller 303 identifies the different resolutions from the communication request.

Alternatively, the controller 303 may identify resolutions that the computing device 103 is configured to send video data in. The controller 303 may access the resolutions from the memory 301 that the computing device 103 is compatible with. The controller 303 may identify a subset of resolutions for the current communication session based on a user input or based on the video application (e.g., video conferencing application).

At act S103, the communication interface 305 or the controller 303 identifies and generates a parameter set table including the plurality of parameter sets and associated resolutions. The parameter set may include one or more PPS identifiers and/or SPS identifiers associated with the resolutions. The parameter set may be sent in response to an options query from the remote endpoint.

At act S105, the communication interface 305 or the controller 303 establishes a communication session with an endpoint. The communication interface 305 may send an acknowledgement message or an accept message to the remote endpoint. The communication session may include video data such as video coding layer units or other video data as provided by video compression protocols (e.g., H.264 or H.265).

At act S107, the communication interface 305 sends the parameter set table to the endpoint as part of the communication session. The parameter set table may include different resolutions based on different endpoint types for the remote endpoint such as a mobile phone, a tablet, a laptop, a video conference terminal, and an internet protocol phone. Alternatively, the different endpoints types include different models of mobile phones or different resolutions for the media stream are associated with different orientations of an endpoint. At act S109, the communication interface 305 sends video data of the media stream to the endpoint as part of the communication session.

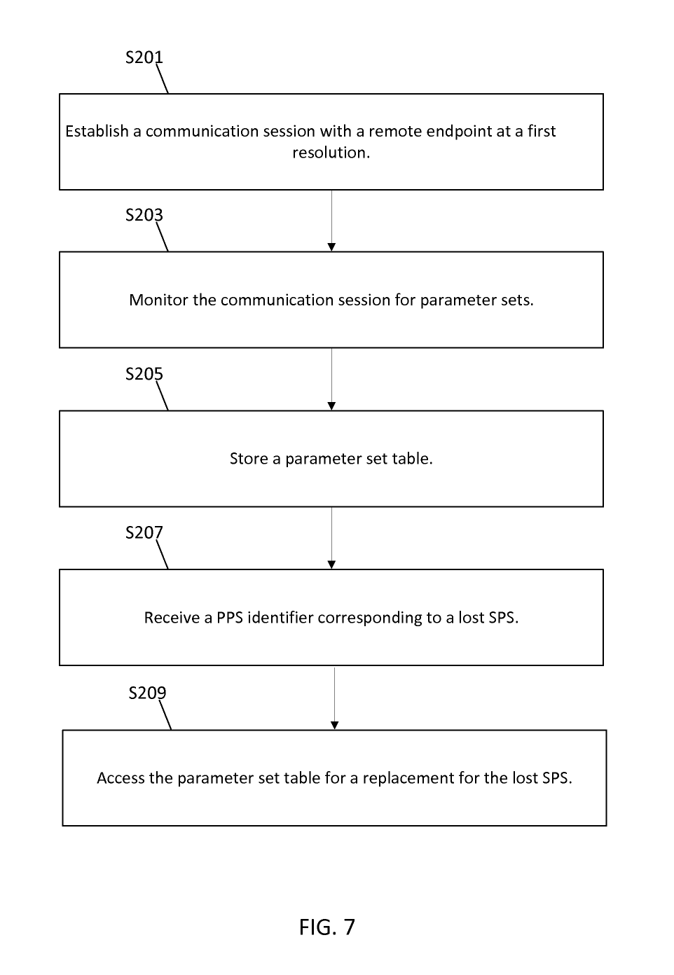

FIG. 7 illustrates an example flowchart for the computing device acting as a decoder. Additional, different, or fewer acts may be provided. The acts are performed in the order shown or other orders. The acts may also be repeated.

At act S201, the controller 303 or the communication interface 305 establishes a communication session with a remote endpoint. The communication session may include video data at a resolution described by one or more parameter sets in the communication session. The resolution may be set by the capabilities of the computing device with the encoder, a setting at the computing device of the encoder, or a current orientation of the computing device of the encoder. As shown by act S203, the controller 303 monitors the communication session for parameter sets.

At act S205, the controller 303 stores the parameter sets in a parameter set table in memory 301. In some examples, the parameter set table may be built by the controller 303 as the parameter sets are identified from the communication session. In other examples, a completed parameter set table is received from the encoder 107.

At act S207, the controller 303 or the communication interface 305 receives a PPS identifier corresponding to a lost SPS. The SPS is lost because the network was lossy and one or more data packets were lost or damaged.

At act S209, the controller 303 accesses a parameter set table according to one of the examples herein using the PPS identifier received in S207. The parameter access table returns an SPS identifier for the lost SPS. The controller 303 may query memory 301 for a replacement SPS for the lost SPS when a corresponding or equivalent SPS has been previously received. If no SPS replacement is available, the controller 303 may modify an error concealment process. In some examples, the error concealment process is suspended. In other examples, the error concealment process is enhanced using SPS data from another SPS or by converting SPS data from another resolution based on a resolution tied to the received PPS identifier.

In one alternative, the resolution of the communication session sent by the encoder 107 may be determined based on a change in orientation or resolution change of the local endpoint device 101 or the computing device. The orientation of the computing device may be detected by an inertial measurement unit (IMU). The IMU may include any combination of accelerometers, compass, altimeters, magnetic sensor, gyroscopes, and global positioning circuitry. The orientation may be received from an orientation module or application programming interface included in a mobile device (e.g., phone, tablet, or other device) to instruct application to change resolutions between landscape mode and portrait mode as the user rotates the mobile device.

The controller 303 may include a general processor, digital signal processor, an application specific integrated circuit (ASIC), field programmable gate array (FPGA), analog circuit, digital circuit, combinations thereof, or other now known or later developed processor. The controller 303 may be a single device or combinations of devices, such as associated with a network, distributed processing, or cloud computing.

The memory 301 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the network device 103, such as a secure digital (SD) memory card.

In addition to ingress ports and egress ports, the communication interface may include any operable connection. An operable connection may be one in which signals, physical communications, and/or logical communications may be sent and/or received. An operable connection may include a physical interface, an electrical interface, and/or a data interface.

The memory 301 is a non-transitory computer-readable medium, which may be a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
identifying, using a processor, a parameter set table that associates sequence parameter set (SPS) identifiers and picture parameter set (PPS) identifiers;
receiving a network abstraction layer unit stream including video data;
identifying a PPS from the network abstract layer unit stream;
accessing the parameter set table using an identifier from the PPS received in the network abstract layer unit stream; and
retrieving an SPS from the parameter set table.

2. The method of claim 1, further comprising:
identifying that a resolution specified by the PPS from the network abstract layer unit stream is different than a previously received SPS.

3. The method of claim 2, further comprising:
enhancing an error concealment algorithm based on the resolution specified by the PPS from the network abstract layer unit stream being different than the previously received SPS.

4. The method of claim 2, further comprising:
modifying an error concealment algorithm based on the resolution specified by the PPS from the network abstract layer unit stream being different than the previously received SPS.

5. The method of claim 4, wherein the modifying the error concealment algorithm comprises:
upsampling or downsampling a portion of the video data.

6. The method of claim 2, further comprising:
freezing a frame of the video data based on the resolution specified by the PPS from the network abstract layer unit stream being different than the previously received SPS.

7. The method of claim 6, further comprising:
receiving a subsequent PPS or SPS in the network abstract layer unit stream; and
advancing the frame of the video data previously frozen in response to the subsequent PPS or SPS.

8. The method of claim 1, further comprising:
identifying that a resolution specified by the PPS from the network abstract layer unit stream is a previously received SPS associated with a different PPS; and
accessing the previously received SPS from memory.

9. The method of claim 1, further comprising:
identifying the SPS identifiers and the PPS identifiers from the network abstract layer unit stream; and
adding an entry to the parameter set table for each pair of one of the SPS identifiers and one of the PPS identifiers.

10. The method of claim 1, further comprising:
receiving the parameter set table from a remote endpoint.

11. An apparatus comprising:
a processor; and
a memory comprising one or more instructions executable by the processor to perform:
identifying, using a processor, a parameter set table that associates sequence parameter set (SPS) identifiers and picture parameter set (PPS) identifiers;
receiving a network abstraction layer unit stream including video data;
identifying a PPS identifier from the network abstract layer unit stream;
accessing the parameter set table using the PPS identifier;
retrieving a PPS from the parameter set table;
identifying an SPS identifier from the PPS;
accessing the parameter set table using the SPS identifier; and
retrieving an SPS from the parameter set table.

12. A method comprising:
identifying a plurality of parameter sets associated with different resolutions for a media stream;
generating a parameter set table including the plurality of parameter sets and associated resolutions;
establishing a communication session with an endpoint;
sending the parameter set table to the endpoint as part of the communication session; and
sending video data of the media stream to the endpoint as part of the communication session.

13. The method of claim 12, wherein the plurality of parameter sets includes a sequence parameter set (SPS) and a picture parameter sets (PPS).

14. The method of claim 12, wherein the different resolutions for the media stream are different resolutions for different endpoint types.

15. The method of claim 14, wherein the different endpoint types include at least two of a mobile phone, a tablet, a laptop, a video conference terminal, and an internet protocol phone.

16. The method of claim 14, wherein the different endpoint types include different models of mobile phones.

17. The method of claim 14, wherein the different resolutions for the media stream are associated with different orientations of an endpoint.

18. The method of claim 12, wherein identifying a plurality of parameter sets associated with different resolutions for the media stream comprises:
receiving a communication request from the endpoint; and
determining the different resolutions from the communication request.

19. The method of claim 12, wherein the video data of the media stream is encoded using network abstraction layer units.

20. An apparatus comprising:
a processor; and
a memory comprising one or more instructions executable by the processor to perform:
identifying a sequence parameter set (SPS) identifier and a picture parameter set (PPS) identifier;
adding an entry to a parameter set table, the entry including the SPS identifier and the PPS identifier;
establishing a network abstraction layer unit stream including video data; and
sending the parameter set table in associated with the network abstraction layer unit stream including video data.
